(19) United States
(12) Patent Application Publication
(10) Pub. No.: US 2013/0339286 A1
(43) Pub. Date: Dec. 19, 2013

(54) REALTIME TREND DETECTION FROM MOBILE DEVICE LOCATION SAMPLES

(71) Applicants: Saar Yahalom, Tel Aviv (IL); Ami Turgman, Tel Aviv (IL); Uri Golani, Tel Aviv (IL)

(72) Inventors: Saar Yahalom, Tel Aviv (IL); Ami Turgman, Tel Aviv (IL); Uri Golani, Tel Aviv (IL)

(73) Assignee: Microsoft Corporation, Redmond, WA (US)

(21) Appl. No.: 13/526,565

(22) Filed: Jun. 19, 2012

(51) Int. Cl. G06N 5/02

(52) U.S. Cl. 706/47

(57) ABSTRACT

Architecture that detects emerging trends in realtime based on sampling from mobile devices. Realtime detection is obtained for events (e.g., entertainment, sporting, religious, etc.) and gatherings (e.g., groups of people), locations (e.g., geographical location of a gathering), for example. Time-based samples are obtained from each subscribing mobile device and then merged into a time-series of location data on which detection is performed. Trend rules are processed as part of the detection process to identify specific trends defined by the rules. Detected trends are announced to the subscribing consumers and are immediately made functionally available for consumption for any subscribing entity. A datastore stores the trend rules, which are updatable at any point in time and functional immediately after being updated and uploaded to the database. This applies equally to new rules uploaded to the database. Thus, detected trends are available for consumption in near realtime.

### BACKGROUND

Trend analysis is an effective technique in many areas of business, for example, to determine patterns in information, which can then impact the business bottom line. Trend analysis is typically performed on persisted data such as associated with data mining. The traditional techniques for deriving emerging trends introduce a significant technical challenge and investment in resources.

When operating outside persisted data regimes, there is no easy and efficient way to determine in realtime that a street concert is or will be taking place at a specific moment in time only a few blocks away, or that a basketball game is or will be taking place at a park, for example. Although this may be accomplished in a non-realtime environment, the commercial benefits may be reduced or lost entirely, especially in the highly social and connected environments that now exist.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture detects emerging trends in realtime such as for realtime detection of emerging trends for events (e.g., entertainment, sporting, religious, etc.) and gatherings (e.g., groups of people), realtime detection of trending locations (e.g., geographical location of a gathering).

Time-based samples are obtained from each subscribing mobile device. The samples are then merged into a time-series of location data on which detection is performed. Trend rules are processed as part of the detection process to identify specific trends defined by the rules. Detected trends are announced to the subscribing consumers and are immediately made functionally available for consumption for any subscribing entity. Interested parties can register to receive announcements for specific trend types and receive alerts in realtime when such a trend is detected.

The architecture maintains a datastore (e.g., database) of trend rules. A trend rule includes a specific trend definition and a related algorithm that operates on the time-series to detect a specific trend related to the trend definition. Realtime trend detection employs trend definitions and detection logic that are updatable at any point in time and are functional immediately after being updated and uploaded to the database. This applies equally to new rules uploaded to the database. Thus, detected trends are available for consumption at or near realtime.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system of trend detection from mobile devices.

FIG. 3 illustrates an exemplary trend rule.

FIG. 4 illustrates a method in accordance with the disclosed architecture.

FIG. 5 illustrates further aspects of the method of FIG. 4.

FIG. 6 illustrates an alternative method in accordance with the disclosed architecture.

FIG. 7 illustrates further aspects of the method of FIG. 6.

FIG. 8 illustrates a block diagram of a computing system that executes realtime trend detection in accordance with the disclosed architecture.

### DETAILED DESCRIPTION

The disclosed architecture facilitates the detection of emerging trends in realtime. The system collects location samples (e.g., periodically, continuously) from registered users (mobile devices thereof) and in combination with the user profiles that function as filters related to likes and dislikes. The collected samples are merged into a time-series that is analyzed for the trends or inferred as to emerging trends. Trend rules are applied that employ trend definitions (e.g., updatable) and related algorithms (e.g., updatable) to infer and identify the actual trends which are occurring, in realtime. Identified trends are then made available to subscribing users (e.g., of the mobile devices) for desired purposes.

As part of the architecture, geographic locations and points of interest can be tagged or identified as places where users will likely congregate or have in the past congregated and at which times (e.g., related to game time). For example, a baseball stadium is well-known to attract baseball fans. However, it can also be the case that baseball fans tend to gather at a specific bar or bars before a game. Thus, when trend detection indicates “crowding” of users who like sports, and in particular, baseball, at a location at a certain time, it can be inferred to be a bar frequented before a baseball game starts.

The trends can be detectable as long and short period trends (as detected by written scripts). A short period trend is short in time (e.g., the last twenty-four hours, the last thirty minutes, etc.), while a long trend is identifiable of a longer period of time (e.g., the last two weeks). For example, a short trend can be detectable as a group of users playing basketball at a basketball court. A long period trend is typically associated with a place that does not move such as the basketball court.

The following scenarios are examples which are enabled by the disclosed trend detection architecture. In a first example, a user can detect local active basketball courts where users are currently playing. By employing a trend rule which searches (is processed over a database of time-based samples) for gatherings of basketball players in a single location at a specified time range (e.g., for at least forty minutes) every day outside of work hours, the location of active basketball courts can be detected.

In another example, basketball games can be detected in realtime. After determining the basketball court geographical locations throughout an area (e.g., neighborhood, city, etc.) a rule can be created and enabled to detect in realtime when games actually occur at these identified locations. This can be inferred as a trend by the “crowding” (congregating) of users who typically play basketball, as indicated by realtime samples obtained from the associated mobile devices of the users “gathering” at a specific basketball court.

In yet another example, detection can be made of locations that are trending “in” (increasing or likely to increase in attendance by users) and “out” (decreasing or likely to decrease in attendance by users) by determining if certain types of people have lingered in these places, or stopped visiting a place altogether. These “certain types” of people can be ascertained by user profiles created by the users, and/or by profiles developed for the users.

In still another example, events occurring in places such as parks, downtown, or by the harbor, for example, can be detected from samples obtained in realtime from mobile devices (of users) that appear to be migrating to a specific geographical location or point of interest. In another example, mass gatherings can be detected before such gatherings peak in attendance (e.g., riots). In other words, for security and safety purposes, where trend(s) indicate a gathering is likely to be occurring, police can be notified and proactively prepare, if needed.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

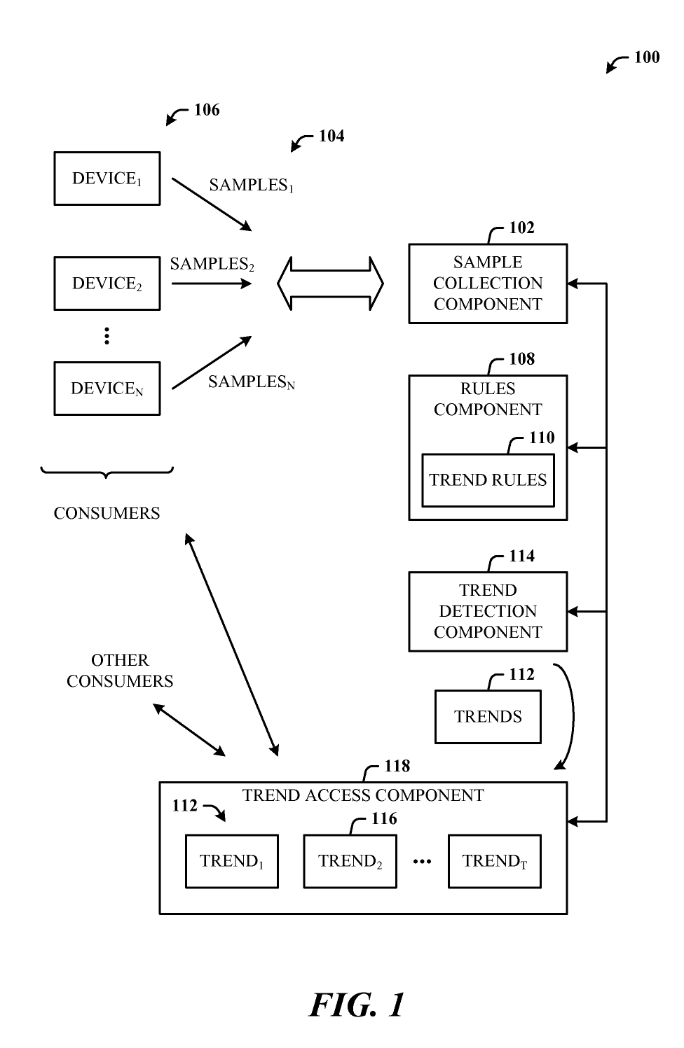

FIG. 1 illustrates a system 100 in accordance with the disclosed architecture. The system 100 can include a sample collection component 102 that collects samples 104 of geolocation information (e.g., physical coordinates of latitude and longitude) in realtime from multiple mobile devices 106. A rules component 108 stores trend rules 110 for identifying trends 112 from the samples 104. A trend detection component 114 applies the trend rules 110 to the samples and identifies a trend 116 (of the trends 112) in realtime. A trend access component 118 enables communication of the identified trend 116 to a consumer (e.g., application, client, user, etc.), which can be any one or more of the mobile devices 106, or systems other than the mobile devices 106.

The samples can be time-based samples collected from the mobile devices 106 on a repetitive basis (e.g., continuously, periodically according to a time interval (e.g., every x seconds), etc.) and processed as a time series. The trend 116 is detected further based on user profiles associated with devices (of the devices 106) from which the samples are obtained. Each device user can complete a user profile as part of subscribing to the disclosed architecture.

The rules component 108 enables update of an existing rule (e.g., trend rules 110) as an updated rule and implementation of a new rule. The updated rule and the new rule are functionally available for trend detection when uploaded to the rules component 108. Each trend rule can be used to identify a different trend or multiple trends.

One or more of the trend rules 110 is applied to the samples 104 in realtime to detect corresponding one or more trends. A trend relates to a geographic location. The trend rule comprises a trend definition and an algorithm specific to the processing the trend definition. The identified trend can relate to an event or a gathering of people. As previously described, the identified trend can be announced and made available to a subscribing consumer.

In other words, the architecture can detect emerging trends in realtime. Geographic location samples are collected from registered users together with the user profiles. A set of updatable trend definitions is then employed to infer and/or identify the actual trends which are occurring, in realtime. Trend(s), at any moment in time, are then available for consumption by any interested party (e.g., which subscribes to access such trend information) by any digital means.

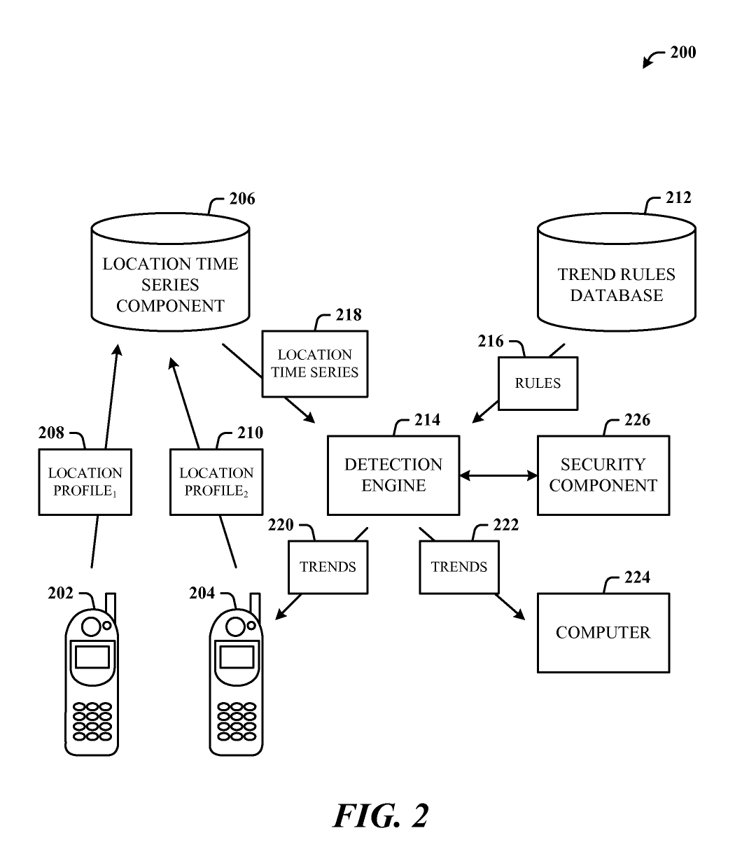

FIG. 2 illustrates a system 200 of trend detection from mobile devices. Here, two mobile devices (202 and 204) are configured and enabled to send samples of location information (location time series) to a time series component 206. The times series component 206 can be any fast memory system that supports realtime time series processing, such as cache memory. The users of the mobiles devices (202 and 204) also have associated location profiles (208 and 210) that are uploaded to the time series component 206 as well.

A trend rules database 212 (as part of the rules component 108) is maintained. Each trend rule comprises a trend definition and an algorithm that is used to detect a specific kind of trend. The trending rules are made available as soon as the rules are added to the database 212. The trend rule is updatable at any time, and the updated version of the rule can be used as soon as the rule completes update. The update may be directed to the definition, the algorithm, or both.

A detection engine 214 (similar to the trend detection component 114) performs trend detection by applying (running) one or more rules 216 (that include trend definitions and updatable algorithms) against locations time series 218 selected from the time series component 206 to detect realtime trends 220 and 222. The detected trends 220 and 222 are announced (e.g., published, pushed, etc.) and immediately made available for consumption by any subscribing entity (e.g., user, device, application, etc.). Here, tow subscribing entities are shown, the mobile device 204 receives the trends 220 and a computer 224 receives the trends 222. Interested parties can register (subscribe) to receive or get notifications for specific trend types and receive alerts in realtime when such a specific trend (or trends) is/are occurring. Another approach can be to poll the system for all the currently detected events.

The signal collection process is based on crowd sourcing where multiple users (user devices) enable the communication and collection of location samples over a predetermined period of time. Crowd sourced locations create a vast location time series that is used for trend detection. Registered users transmit their location information (e.g., every x minutes) together with their profiles. A user profile can include user preferences (e.g., the user likes or dislikes), which kind of music, foods, or hangout styles the user prefers, and so on. The profile can include many types of user preferences information related to the given user, in addition to the previous examples, such as works days, age, sex, talents, preferred characteristics of friends, and many more. Users can join and exit the system freely. Users can join by running a given piece of software on their mobile devices (e.g., phones, laptops, PDAs, etc.).

Given that the disclosed architecture deals with personal information such as profiles, preferences, and location information, an optional security component 226 can be employed for authorized and secure handling of user information. The security component 226 enables the subscriber to opt-in and opt-out of data identification and tracking at any given time.

If opting-in, the subscriber can be provided with notice of the collection of personal information, for example, and the opportunity to provide or deny consent to do so. Consent can take several forms. Opt-in consent imposes on the subscriber to take an affirmative action before the data is collected. Alternatively, opt-out consent imposes on the subscriber to take an affirmative action to prevent the collection of data before that data is collected. This is similar to implied consent in that by doing nothing, the subscriber allows the data collection after having been adequately informed.

The security component 226 can also enable the subscriber to access and update profile information. For example, the subscriber can view the personal and/or data that have been collected, and provide corrections. Where sensitive personal information such as health and financial information can be tracked and obtained during subscription or thereafter, the security component 226 ensures that the data is protected using security measures appropriate for the sensitivity of the data.

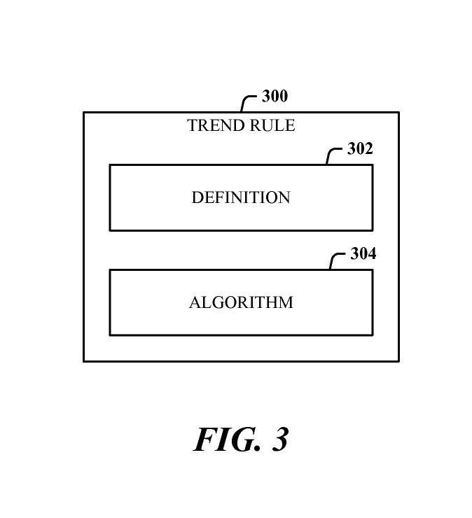

FIG. 3 illustrates an exemplary trend rule 300. The rule 300 includes a trend definition 302 and a trend algorithm 304. The definition 302 defines the time series data the trend rule 300 is designed to detect, for example, a simplistic definition is “a basketball court is where people who like basketball gather”. The algorithm 304 is executed by the detection engine 214 to process the time-series from the time series component 206. As previously indicated, the definition 302 and algorithm are updatable and available for processing in or near realtime. It is within contemplation that the rule 300 can be designed to include multiple definitions and associated algorithms.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

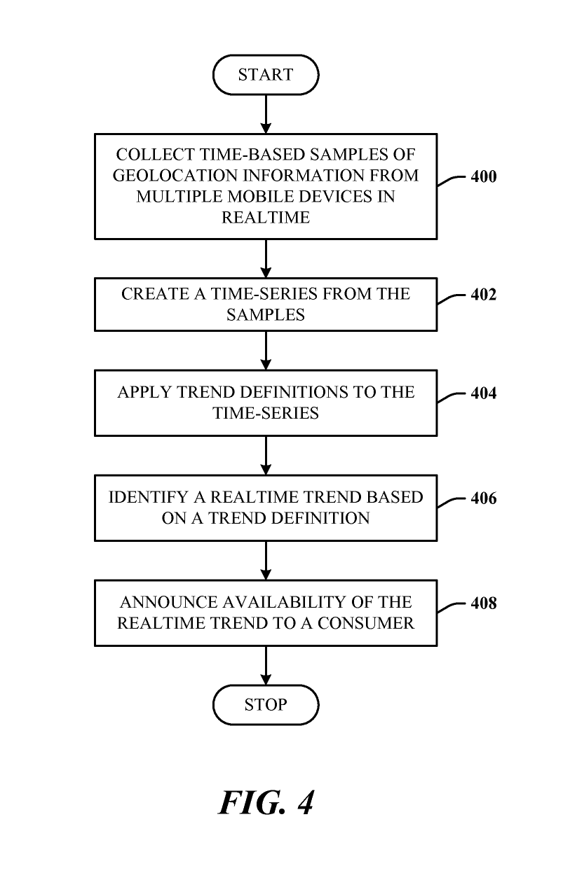

FIG. 4 illustrates a method in accordance with the disclosed architecture. At 400, time-based samples of geolocation information are collected from multiple mobile devices in realtime. At 402, a time-series is created from the samples. At 404, trend definitions are applied to the time-series. At 406, a realtime trend is identified based on a trend definition. At 408, availability of the realtime trend is announced to a consumer.

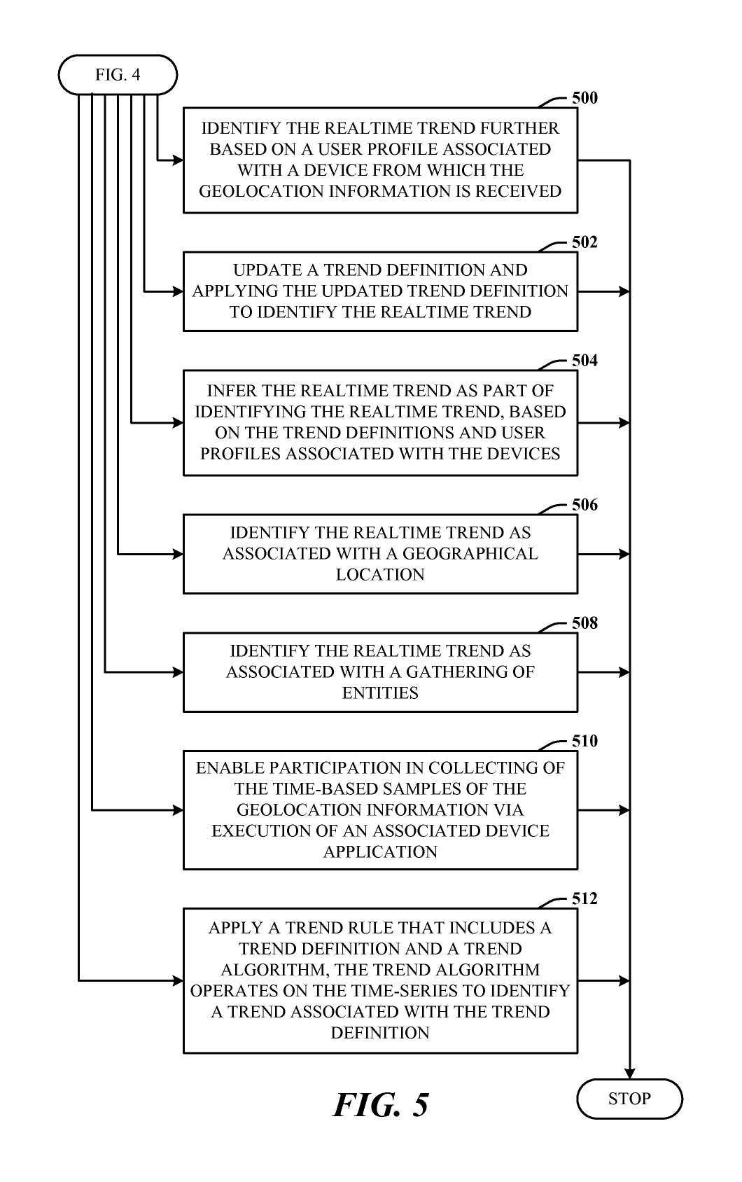

FIG. 5 illustrates further aspects of the method of FIG. 4. Note that the flow indicates that each block can represent a step that can be included, separately or in combination with other blocks, as additional aspects of the method represented by the flow chart of FIG. 5. At 500, the realtime trend is identified further based on a user profile associated with a device from which the geolocation information is received. At 502, a trend definition is updated and the updated trend definition is applied to identify the realtime trend. At 504, the realtime trend is inferred as part of identifying the realtime trend, based on the trend definitions and user profiles associated with the devices. At 506, the realtime trend is identified as associated with a geographical location. At 508, the realtime trend is identified as associated with a gathering of entities. At 510, participation in collecting of the time-based samples of the geolocation information is enabled via execution of an associated device application. At 512, a trend rule is applied that includes a trend definition and a trend algorithm, the trend algorithm operates on the time-series to identify a trend associated with the trend definition.

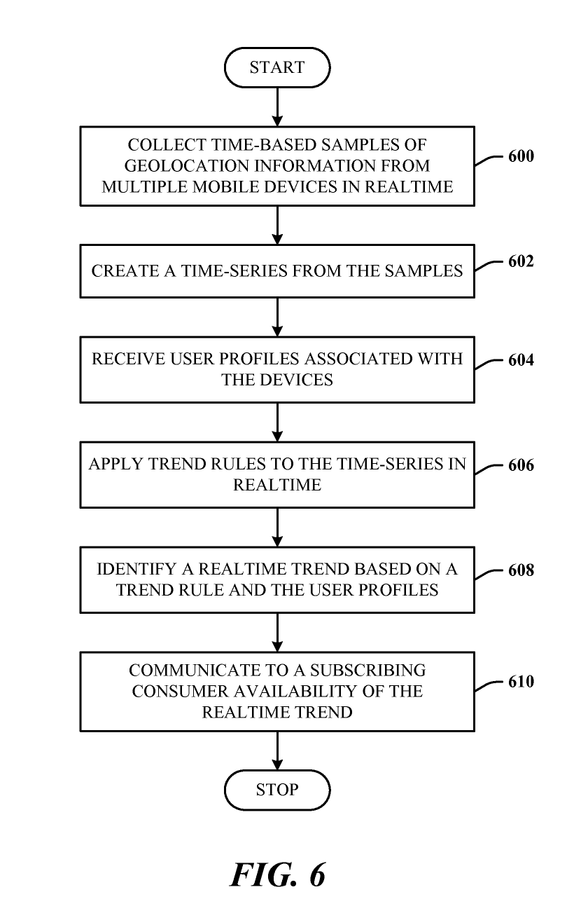

FIG. 6 illustrates an alternative method in accordance with the disclosed architecture. At 600, time-based samples of geolocation information are collected from multiple mobile devices in realtime. At 602, a time-series is created from the samples. At 604, user profiles associated with the devices are received. At 606, trend rules are applied to the time-series in realtime. At 608, a realtime trend is identified based on a trend rule and the user profiles. At 610, availability of the realtime trend is communicated to a subscribing consumer.

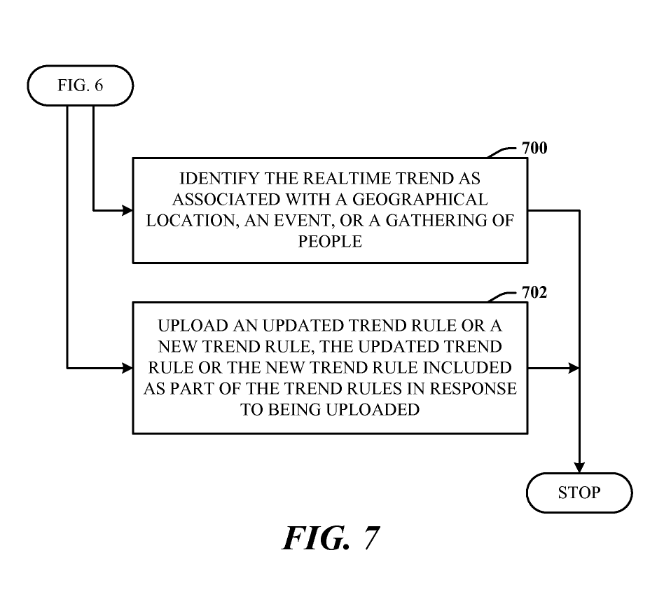

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, the realtime trend is identified as associated with a geographical location, an event, or a gathering of people. At 702, an updated trend rule or a new trend rule is uploaded, the updated trend rule or the new trend rule included as part of the trend rules in response to being uploaded.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

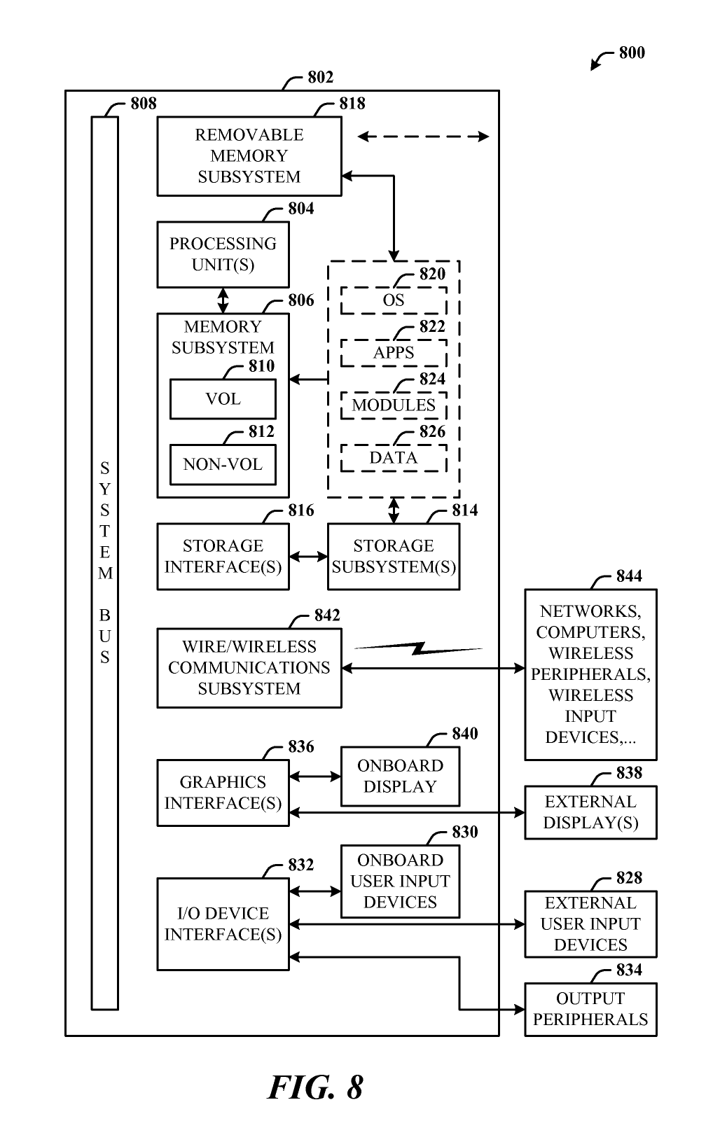

Referring now to FIG. 8, there is illustrated a block diagram of a computing system 800 that executes realtime trend detection in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

It is also to be understood that the disclosed architecture is suited for mobile-capable device such as portable computers, tablets, etc., as well as mobile devices (e.g., cell phones).

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the system memory 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include entities and components of the system 100 of FIG. 1, entities and components of the system 200 of FIG. 2, the rule 300 of FIG. 3, and the methods represented by the flowcharts of FIGS. 4-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a sample collection component that collects samples of geolocation information in realtime from multiple mobile devices;
a rules component that stores trend rules for identifying trends from the samples;
a trend detection component that applies the trend rules to the samples and identifies a trend in realtime;
a trend access component that enables communication of the identified trend to a consumer; and
a microprocessor that executes instructions stored in memory.

2. The system of claim 1, wherein the samples are time-based samples collected from the mobile devices on a repetitive basis and processed as a time series.

3. The system of claim 1, wherein the trend is detected further based on user profiles associated with devices from which the samples are obtained.

4. The system of claim 1, wherein the rules component enables update of an existing rule as an updated rule and implementation of a new rule, the updated rule and the new rule are functionally available for trend detection when uploaded to the rules component.

5. The system of claim 1, wherein each trend rule is used to identify a different trend, one or more of the trend rules applied to the samples in realtime to detect corresponding one or more trends.

6. The system of claim 1, wherein the trend relates to a geographic location.

7. The system of claim 1, wherein a trend rule comprises a trend definition and an algorithm specific to the processing the trend definition.

8. The system of claim 1, wherein the identified trend relates to an event or a gathering of people.

9. The system of claim 1, wherein the identified trend is announced and made available to a subscribing consumer.

10. A method, comprising acts of:
collecting time-based samples of geolocation information from multiple mobile devices in realtime;
creating a time-series from the samples;
applying trend definitions to the time-series;
identifying a realtime trend based on a trend definition;
announcing availability of the realtime trend to a consumer; and
utilizing a microprocessor to execute instructions stored in memory.

11. The method of claim 10, further comprising identifying the realtime trend further based on a user profile associated with a device from which the geolocation information is received.

12. The method of claim 10, further comprising updating a trend definition and applying the updated trend definition to identify the realtime trend.

13. The method of claim 10, further comprising inferring the realtime trend as part of identifying the realtime trend, based on the trend definitions and user profiles associated with the devices.

14. The method of claim 10, further comprising identifying the realtime trend as associated with a geographical location.

15. The method of claim 10, further comprising identifying the realtime trend as associated with a gathering of entities.

16. The method of claim 10, further comprising enabling participation in collecting of the time-based samples of the geolocation information via execution of an associated device application.

17. The method of claim 10, further comprising applying a trend rule that includes a trend definition and a trend algorithm, the trend algorithm operates on the time-series to identify a trend associated with the trend definition.

18. A method, comprising acts of:
collecting time-based samples of geolocation information from multiple mobile devices in realtime;
creating a time-series from the samples;
receiving user profiles associated with the devices;
applying trend rules to the time-series in realtime;
identifying a realtime trend based on a trend rule and the user profiles;
communicating to a subscribing consumer availability of the realtime trend; and
utilizing a microprocessor to execute instructions stored in memory.

19. The method of claim 18, further comprising identifying the realtime trend as associated with a geographical location, an event, or a gathering of people.

20. The method of claim 18, further comprising uploading an updated trend rule or a new trend rule, the updated trend rule or the new trend rule included as part of the trend rules in response to being uploaded.
